(19) United States
(12) Patent Application Publication
(10) Pub. No.: US 2015/0355845 A1
(43) Pub. Date: Dec. 10, 2015

(54) MEMORY SYSTEMS THAT SUPPORT READ RECLAIM OPERATIONS AND METHODS OF OPERATING SAME TO THEREBY PROVIDE REAL TIME DATA RECOVERY

(71) Applicant: Samsung Electronics Co., Ltd., Suwon-si (KR)

(72) Inventors: Kwang-Jin Lee, Yongin-si (KR); Seonghun Kim, Suwon-si (KR); Jeong-Han Kim, Hwaseong-si (KR); Sunghee Lee, Osan-si (KR); Sanggyu Jang, Hwaseong-si (KR); Hong Suk Choi, Hwaseong-si (KR)

(21) Appl. No.: 14/729,518

(22) Filed: Jun. 3, 2015

(30) Foreign Application Priority Data
Jun. 5, 2014 (KR) 10-2014-0068555

(51) Int. Cl. G06F 3/06

(52) U.S. Cl. CPC G06F 3/0608; G06F 3/0644; G06F 3/0667; G06F 3/0679; G06F 3/0653

(57) ABSTRACT

Methods of operating nonvolatile memory devices include counting a number of consecutive read operations performed on a first memory region within the nonvolatile memory device, and executing a page reclaim operation on the first memory region in response to detecting that a count in the number of consecutive read operations meets or exceeds a threshold count. A page reclaim operation may include checking an error bit level within a page of data stored in a multi-level cell block within the memory device. The page reclaim operation may further include moving page data from the multi-level cell block to a single-level cell block in the memory device and error correcting the page data during the moving.

### REFERENCE TO PRIORITY APPLICATION

This U.S. non-provisional patent application claims priority under 35 U.S.C. §119 to Korean Patent Application No. 10-2014-0068555, filed on Jun. 5, 2014, the entire contents of which are hereby incorporated by reference.

### BACKGROUND OF THE INVENTION

The inventive concept relates to semiconductor memory devices, and more particularly, to a memory system based on a nonvolatile memory and a reclaim operation.

A semiconductor memory device may be classified into a volatile memory device such as a DRAM, a SRAM, etc. and a nonvolatile memory device such as an EEPROM, a FRAM, a PRAM, a MRAM, a flash memory, etc. A volatile memory device loses its stored data when its power source is disconnected while a nonvolatile memory device retains its stored data even when its power source is disconnected. A flash memory has advantages of a high programming speed, low power consumption, a high-capacity data storage, etc. Thus, a memory system including a flash memory is being widely used as data storage medium. A flash memory device stores bit information by injecting charge into a floating gate isolated by an insulating layer. However, because of a capacitive coupling problem that exists between memory cells or between a memory cell and a select transistor (GSL, SSL), the floating gate structure is being considered as a structure having a physical limit in high density integration.

As an alternative to solving a capacitive coupling problem between floating gates, a charge trap flash (CTF) memory structure using an insulating layer such as Si₃N₄, Al₂O₃, HfAlO, HfSiO, etc. as a charge storage layer is being suggested. A charge trap flash (CTF) memory device may be applied to a three-dimensional flash memory device to overcome a physical limit of high density integration. Because of a structural feature of using an insulating layer as a charge storage layer, in a charge trap flash (CTF) memory device, electrons or holes in a charge storage layer are rearranged or recombined after a program or erase operation and thereby threshold voltages of flash memory cells may be changed. If threshold voltages of flash memory cells are changed beyond their programmed data range due to a disturb phenomenon in a read operation, UECC (uncorrectable error correction code), an error uncorrectable by ECC operation, may occur in read data.

### SUMMARY

Embodiments of the inventive concept provide a read reclaim method. The read reclaim method may include checking whether a read command consecutively occurs more than a specific number of times, and setting an operation mode to a page reclaim enable state during a read operation, in the event the read command consecutively occurs more than the specific number of times. A page reclaim is then executed during the read operation upon occurrence of a page reclaim event.

Embodiments of the inventive concept also provide a read reclaim method. The read reclaim method may include detecting whether a read command consecutively occurs more than a specific number of times; checking an error bit level with respect to data of memory cells connected to word lines adjacent to a select word line during a read operation in the case that the read command consecutively occurs more than the specific number of times; storing data of memory cells connected to a reclaim factor word line in the case that a reclaim is needed; and moving data of memory cells connected to the stored reclaim factor word line to memory cells connected to a word line of a new memory block when a write command is received.

Embodiments of the inventive concept also provide a memory system. The memory system may include a nonvolatile memory having a memory region; and a memory controller having a partial reclaim manager. In the event a read command consecutively occurs more than a specific number of times, after setting an operation mode to a page reclaim enable state in a read operation, in the case a page reclaim event occurs, the partial reclaim manager executes a page reclaim during the read operation.

### BRIEF DESCRIPTION OF THE FIGURES

Embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a block diagram illustrating a memory system in accordance with an inventive concept.

FIG. 2 is a block diagram illustrating an embodiment of a memory controller illustrated in FIG. 1.

FIG. 3 is a block diagram illustrating another embodiment of a memory controller illustrated in FIG. 1.

FIG. 4 is a block diagram illustrating a flash memory that may be used in the inventive concept.

FIG. 5 is a perspective view illustrating a three-dimensional structure of a memory block BLK1 illustrated in FIG. 4.

FIG. 6 is an equivalent circuit of the memory block BLK1 illustrated in FIG. 5.

FIG. 7 is a drawing for explaining a charge loss phenomenon of a single level cell (SLC).

FIG. 8 is a drawing for explaining a charge loss phenomenon of a 2-bit multi level cell (MLC).

FIG. 9 is a flow chart for explaining a read reclaim operation for recovering real time data according to embodiments of the inventive concept.

FIG. 10 is a schematic view for explaining a reclaim operation method for removing a disturb factor according to embodiments of the inventive concept.

FIG. 11 is a flowchart for explaining an operational relationship between a read reclaim setting and a counting unit when power is supplied according to embodiments of the inventive concept.

FIG. 12 is a flow chart for explaining a reclaim operation for removing a disturb factor according to FIG. 10.

FIG. 13 is a block diagram illustrating an embodiment of a memory system in accordance with the inventive concept.

FIG. 14 is a block diagram illustrating another embodiment of a memory system in accordance with the inventive concept.

FIGS. 15 and 16 are block diagrams illustrating other various embodiments of a memory system in accordance with the inventive concept.

FIG. 17 is a block diagram illustrating a memory card system including a memory system in accordance with the inventive concept.

FIG. 18 is a block diagram illustrating a solid state drive (SSD) system including a memory system in accordance with the inventive concept.

FIG. 19 is a block diagram illustrating an embodiment of the SSD controller illustrated in FIG. 18.

FIG. 20 is a block diagram a memory system in accordance with the inventive concept embodied by an electronic device.

### DETAILED DESCRIPTION OF PREFERRED EMBODIMENTS

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer. Each vertical NAND string further may includes at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

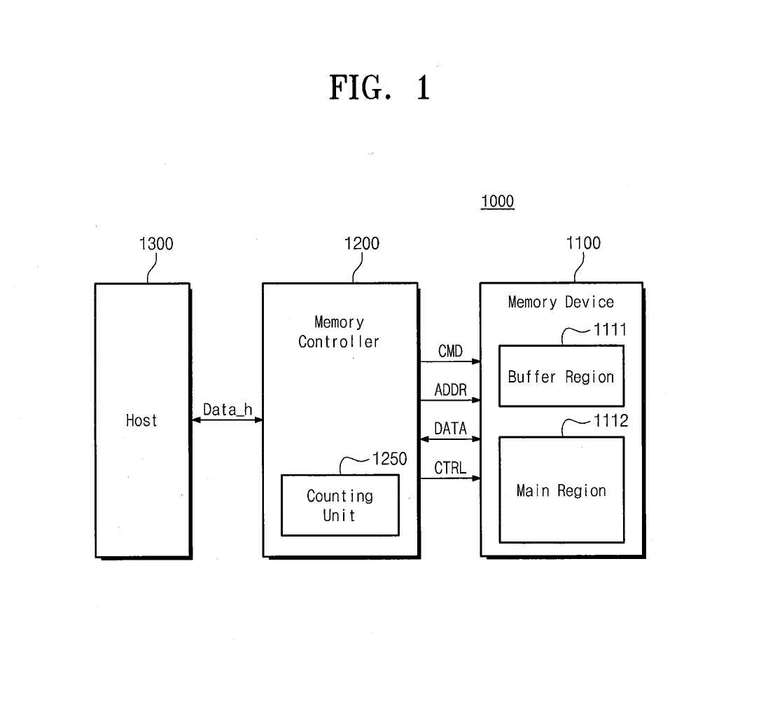

FIG. 1 is a block diagram illustrating a memory system in accordance with inventive concept. Referring to FIG. 1, a memory system 1000 includes a memory device 1100 and a memory controller 1200. The memory controller 1200 may be connected to a host 1300. The memory device 1100 is controlled by the memory controller 1200 and can perform operations (for example, a read or program operation, etc.) corresponding to a request of the memory controller 1200. The memory device 1100 includes a buffer region 1111 and a main region 1112. The buffer region 1111 may be constituted by a single level cell (SLC) storing 1-bit data per cell. The main region 1112 may be constituted by a multi level cell (MLC) storing N-bit data (N is an integer which is 2 or greater than 2) per cell. Alternatively, each of the buffer and main regions 1111 and 1112 may be constituted by a multi level cell (MLC). In this case, a multi level cell of the buffer region 1111 may perform a LSB program operation so that the multi level cell operates in a manner of a single level cell.

In alternative embodiments, each of the buffer and main regions 1111 and 1112 may be constituted by a single level cell (SLC). The buffer and main regions 1111 and 1112 may be embodied by one memory device or separate memory devices. Data stored in the buffer region 1111 may be data provided from the outside by a write request of the host 1300.

The memory controller 1200 is connected between the memory device 1100 and the host 1300. The memory controller 1200 controls read and write operations with respect to the memory device 1100 in response to a request of the host 1300. The memory controller 1200 can be inputted with host data Data_h from the host 1300 and can transmit data DATA to the memory device 1100. The memory controller 1200 can provide a command CMD, an address ADDR, data DATA and a control signal CTRL to the memory device 1100.

The memory controller 1200 manages a mapping table including a logical address LA and a physical address PA. The memory controller 1200 includes a counting unit 1250. The counting unit 1250 checks whether read commands are requested more than the specific number of times consecutively from the host 1300. The counting unit 1250 can increase a counting value for each read command received from the host 1300. If a write command is received when a counting value of the read command is less than the specific number of times or regardless of a counting value of the read command, the counting unit 1250 may be reset.

If a read command occurs consecutively exceeding the specific number of times, the memory controller 1200 may set an operation mode to a page reclaim enable state to perform a page reclaim while a read operation is performed. When a page reclaim event occurs, the memory controller 1200 performs the page reclaim by controlling the memory device 1100 during a read operation. Thus, data recovery is performed in real-time during the read operation. The read operation is an operation based on a command reference of the host 1300 and even in case of receiving a read command, a data write operation may be performed in the memory device 1100 to perform a read reclaim during the read operation.

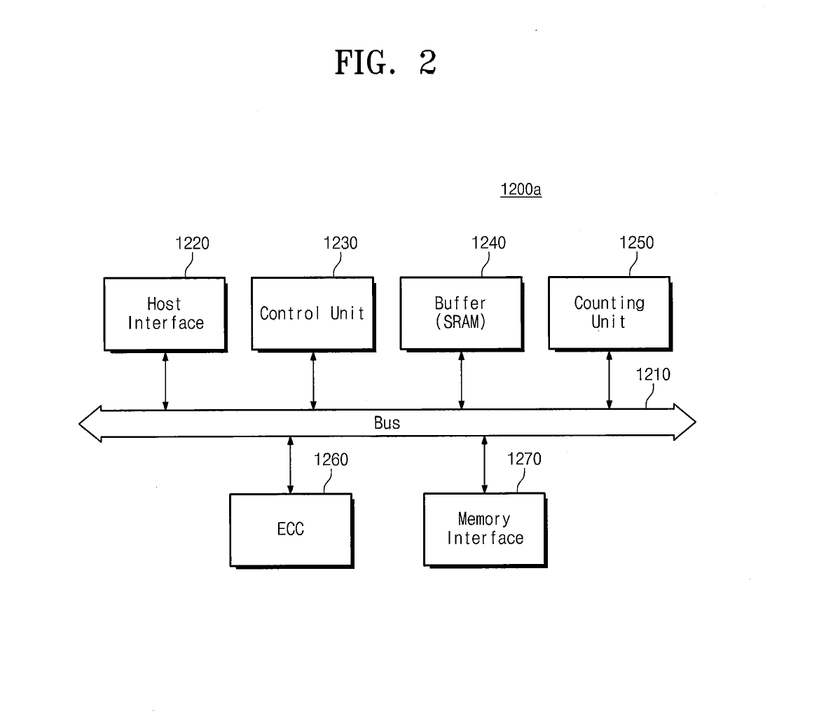

Unlike of controlling a read reclaim during a read operation, after receiving a write command, the memory controller 1200 can control a page reclaim in a write operation. In this case, the memory controller 1200 detects whether a read command consecutively occurs more than the specific number of times and in the case that the read command consecutively occurs more than the specific number of times, checks an error bit level with respect to data of memory cells connected to word lines adjacent to a select word line during the read operation. The memory controller 1200 also stores data of memory cells connected to a reclaim factor word line (in case of SLC, a page) in a buffer 1240 (refer to FIG. 2) constituted by a memory such as a SRAM, etc. when a reclaim is needed. When a write command is received after the read operation is completed, the memory controller 1200 moves the stored data of memory cells connected to a reclaim factor word line to memory cells connected to a word line of a new memory block.

The counting unit 1250 in the memory controller 1200 and a control unit 1230 of FIG. 2 can function as a partial reclaim manager. In the case that a read command consecutively occurs more than the specific number of times from the host 1300, partial reclaim manager sets an operation mode to a page reclaim enable state during a read operation and then performs a page reclaim during the read operation in case of a page reclaim event.

The memory system 1000 can effectively perform a read reclaim in a repetitive read operation while minimizing or reducing performance degradation in the read operation. In the case that a read operation is continuously repeated without a write operation, the memory system 1000 can also perform a read reclaim during the read operation. When a reclaim with respect to data of memory cells connected to word lines adjacent to a select word line is needed, the memory system 1000 stores data of memory cells connected to a reclaim factor word line and then reclaims the data in a write operation.

FIG. 2 is a block diagram illustrating an embodiment of a memory controller illustrated in FIG. 1. Referring to FIG. 2, a memory controller 1200a includes a system bus 1210, a host interface 1220, a control unit 1230, a SRAM 1240, a counting unit 1250, an error correction code (ECC) unit 1260 and a memory interface 1270. The system bus 1210 provides a channel among the host interface 1220, the control unit 1230, a SRAM 1240, the counting unit 1250, the error correction code (ECC) unit 1260 and the memory interface 1270. The host interface 1220 can communicate with the host 1300 according to a specific communication standard. The memory controller 1200 can communicate with the host 1300 through at least one of various communication standards such as a USB (universal serial bus), a MMC (multimedia card), a PCI (peripheral component interconnection), a PCI-E (PCI-express), an ATA (advanced technology attachment), a serial-ATA, a parallel-ATA, a SCSI (small computer small interface), an ESDI (enhanced small disk interface), an IDE (integrated drive electronics), and firewire. The control unit 1230 is inputted with host data Data_h and a command from the host 1300 and can control an overall operation of the memory controller 1200. The SRAM 1240 may be used as at least one of an operation memory of an internal operation of the memory controller 1200, a cache memory and a buffer memory.

The counting unit 1250 counts the number of times of read command is performed without an intervening write command. This is because in the case that a read operation is continuously repeated without a write command application, a read reclaim operation is increasingly needed.

The ECC unit 1260 encodes data being received from the host 1300 and generates coding data. The ECC unit 1260 also decodes the coding data from the memory device 1100 and generates original data. Hereinafter, the ECC encoding operation and the ECC decoding operation are referred to as an ECC operation. The memory interface 1270 interfaces with the memory device 1100. For example, the memory interface 1270 may include a NAND flash interface or a VNAND (vertical NAND) interface.

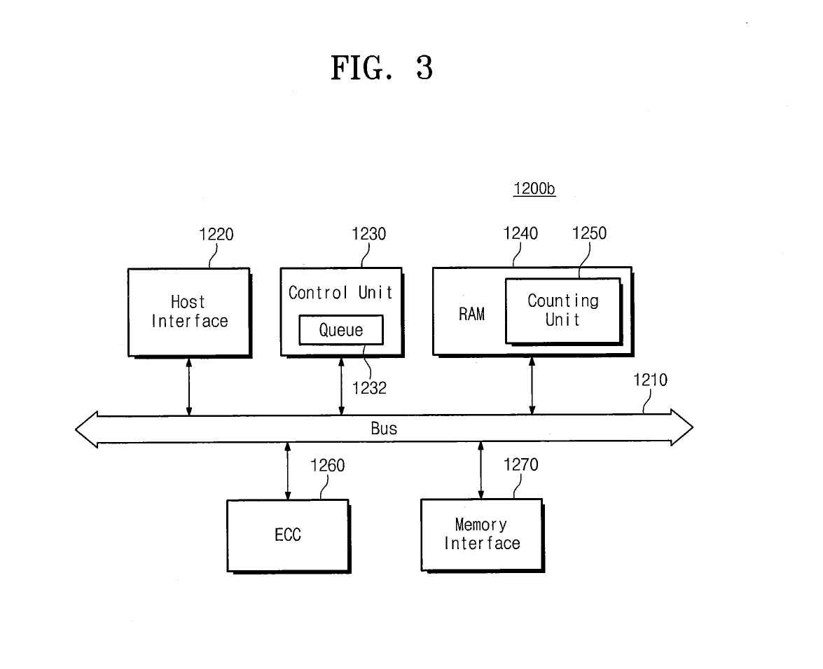

FIG. 3 is a block diagram illustrating another embodiment of a memory controller illustrated in FIG. 1. Referring to FIG. 3, a memory controller 1200b includes the system bus 1210, the host interface 1220, the control unit 1230, a random access memory (RAM) 1240, the counting unit 1250, the ECC unit 1260, and the memory interface 1270. The control unit 1230 may include a reclaim queue 1232 to store reclaim information. In FIG. 3, the counting unit 1250 may be included in the RAM 1240.

Since the remaining constituent elements in FIG. 3 are the same as those in FIG. 2, the description of common features already discussed above will be omitted. The memory device 1100 of FIG. 1 can be applied to not only a two dimensional flash memory but also a three dimensional flash memory (e.g., vertical NAND memory).

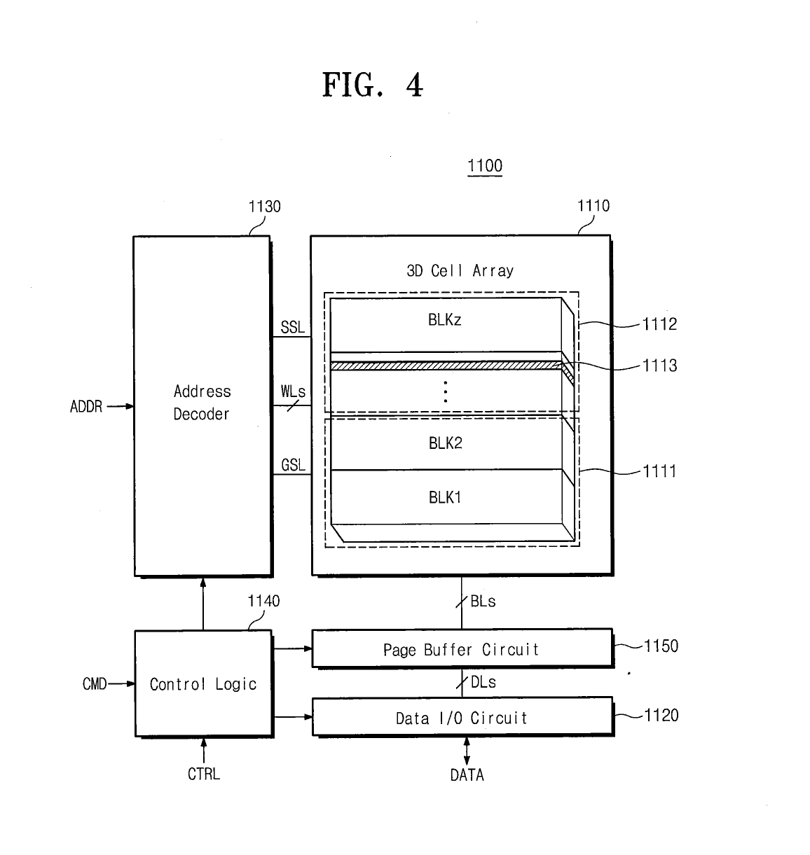

FIG. 4 is a block diagram illustrating a flash memory being used in the inventive concept. The memory device 1100 of FIG. 4 illustrates a three dimensional flash memory. The memory device 1100 includes a three dimensional memory cell array 1110, a data input/output circuit 1120, an address decoder 1130, a page buffer circuit 1150 and control logic 1140. The three dimensional memory cell array 1110 includes a buffer region 1110 and a main region 1112. The three dimensional memory cell array 1110 includes a plurality of memory blocks BLK1˜BLKz. Each of the buffer and main regions 1111 and 1112 can be constituted by a plurality of memory blocks. Each memory block may have a three dimensional structure (or a vertical structure). In a memory block having a two dimensional structure, memory cells are formed in a direction parallel to a substrate. However, in a memory block having a three dimensional structure, memory cells are formed in a direction perpendicular to the substrate. Each memory block constitutes an erase unit of the memory device 1100. The data input/output circuit 1120 is connected to the three dimensional memory cell array 1110 through the page buffer circuit 1150 connected to a plurality of bit lines BLs. The data input/output circuit 1120 is inputted with data from the outside or outputs data read from the three dimensional memory cell array 1110 to the outside. The page buffer circuit 1150 functions as a write driver in a write operation and functions as a data storage latch in a read operation. The address decoder 1130 is connected to the three dimensional memory cell array 1110 through a plurality of word lines WLs and select lines SSL and GSL. The address decoder 1130 is inputted with an address ADDR to select a word line. The control logic 1140 controls program, read and erase operations of the memory device 1100. For example, in a program operation, the control logic 1140 can control the address decoder 1130 so that a program voltage is provided to a select word line and control the data input/output circuit 1120 and the page buffer circuit 1150 so that data is programmed.

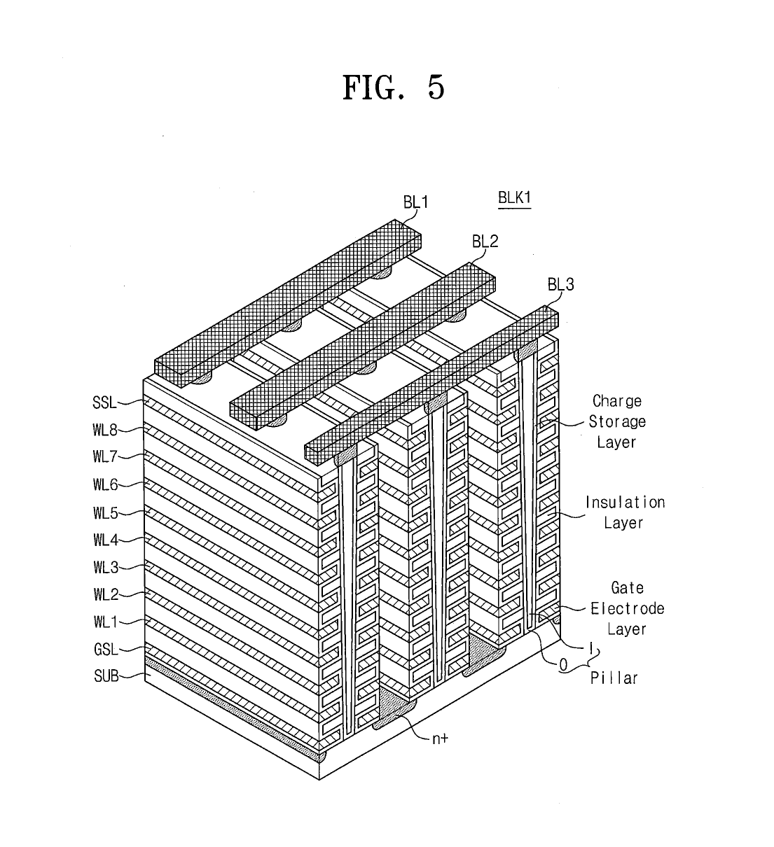

FIG. 5 is a perspective view illustrating a three-dimensional structure of a memory block BLK1 illustrated in FIG. 4. Referring to FIG. 5, the memory block BLK1 is formed in a direction perpendicular to a substrate SUB. An n+ doping region is formed in the substrate SUB. A gate electrode layer and an insulation layer are alternatively deposited on the substrate SUB. A charge storage layer may be formed between the gate electrode layer and the insulation layer. The gate electrode layer and the insulation layer are patterned in a vertical direction to form a pillar of a V shape. The pillar penetrates the gate electrode layer and the insulation layer to be connected to the substrate SUB. An outer part (0) of the pillar may be constituted by a channel semiconductor and an inner part (I) of the pillar may be constituted by an insulation material such as silicon oxide. The gate electrode layer of the memory block BLK1 may be connected to a ground select line GSL, a plurality of word lines WL1˜WL8 and a string select line SSL. The pillar of the memory block BLK1 may be connected to a plurality of bit lines BL. FIG. 5 illustrates that the one memory block BLK1 has two select lines GSL and SSL, eight word lines WL1˜WL8 and three bit lines BL1˜BL3. However, the number of word lines, select lines and bit lines may be greater or less than those of FIG. 5.

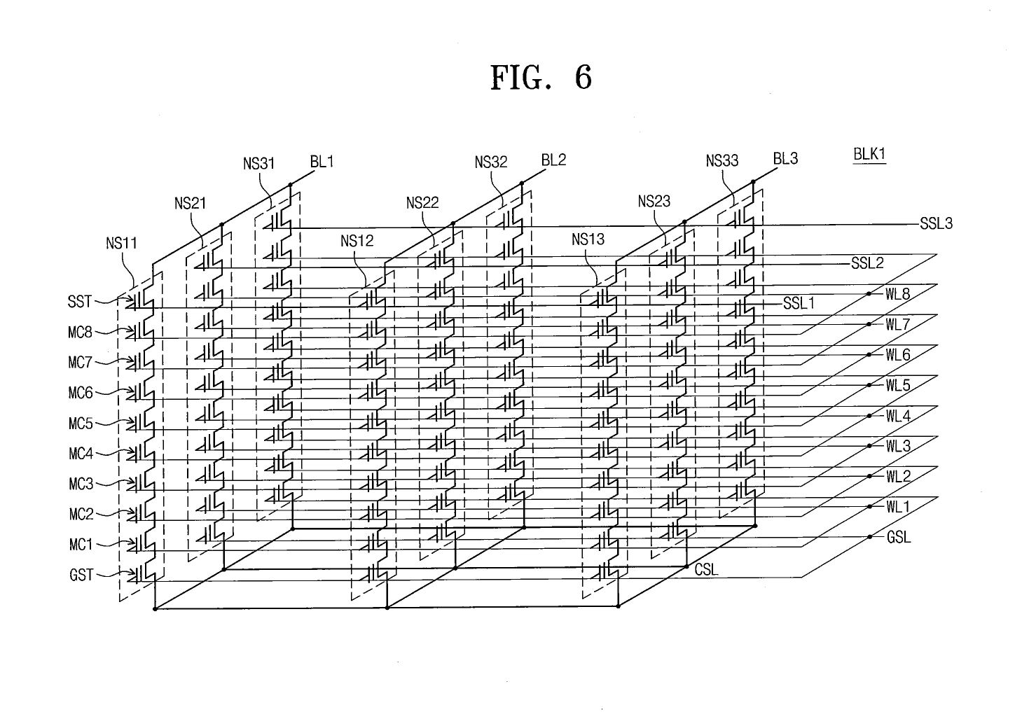

FIG. 6 is an equivalent circuit of the memory block BLK1 illustrated in FIG. 5. Referring to FIG. 6, NAND strings NS11˜NS33 are connected between bit lines BL1˜BL3 and a common source line CSL. Each NAND string (e.g., NS11) includes a string select transistor SST, a plurality of memory cells MC1˜MC8 and a ground select transistor GST. The string select transistors SST are connected to string select lines SSL1˜SSL3. The memory cells MC1˜MC8 are connected to word lines WL1˜WL8 respectively. The ground select transistor GST is connected to a ground select line GSL. The string select transistor SST is connected to the bit line. The ground select transistor GST is connected to the common source line CSL. Word lines (e.g., WL1) having the same height are connected in common and ground select lines GSL are connected in common. String select lines SSL1˜SSL3 are separated from one another. In case of programming memory cells (hereinafter they are referred to as a page) that are connected to the first word line WL1 and belong to NAND strings NS11, NS12 and NS13, the first word line WL1 and the first string select line SSL1 are selected.

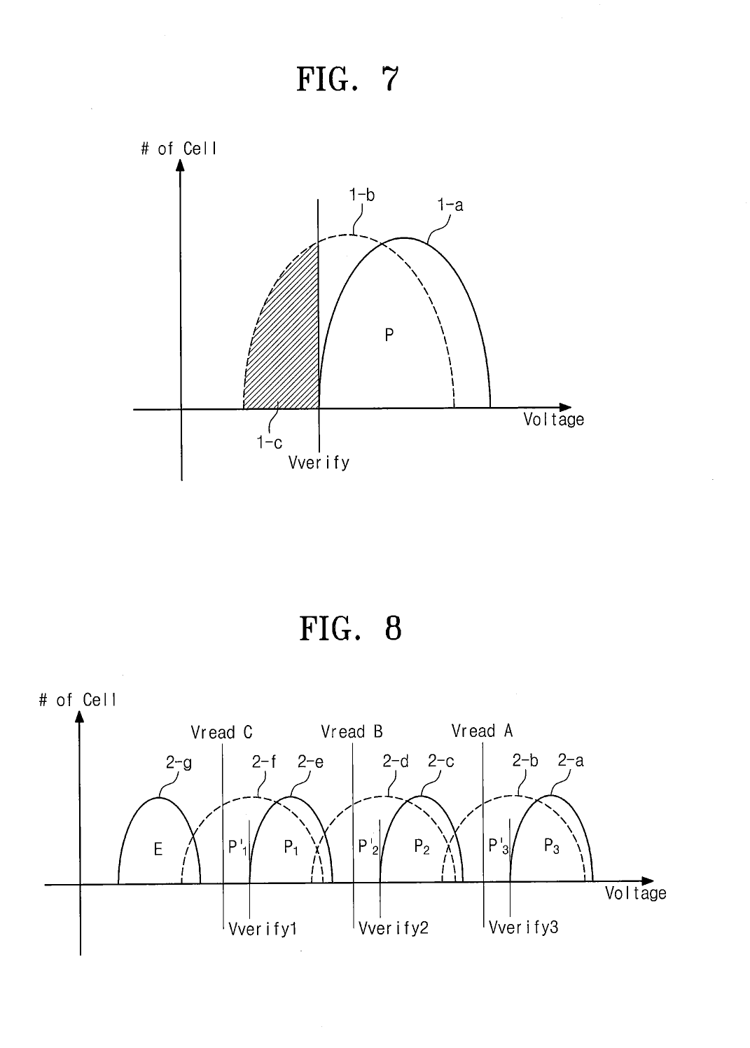

FIG. 7 is a drawing for explaining a charge loss phenomenon of a single level cell (SLC). Referring to FIG. 7, the charge loss phenomenon means that as time goes by after program operation, electrons trapped in a charge storage layer (for example, a floating gate or a tunnel oxide layer) of a flash memory device flow out of the charge storage layer. As the number of times program and erase operations increases, a tunnel oxide layer is deteriorated and thereby a charge loss phenomenon may occur more severely.

In FIG. 7, an x axis represents a voltage and a y axis represents the number of memory cells. A first program state distribution (1-a) represents a program state distribution immediately after a program operation (i.e., a state in which a charge loss phenomenon does not occur) and a second program state distribution (1-b) represents a program state distribution after a charge loss phenomenon occurs. As a charge loss phenomenon occurs, the first program state distribution (1-a) moves to the second program state distribution (1-b). Thus, a part of the second program state distribution (1-b) is located to the left of a verify voltage while the first program state distribution (1-a) is located to the right of the verify voltage. When there are more nonvolatile memory cells corresponding to a part (1-c) of the second program state distribution (1-b), nonvolatile memory cells corresponding to the part (1-c) of the second program state distribution (1-b) may not be corrected by an ECC operation.

FIG. 8 is a drawing for explaining a charge loss phenomenon of a 2-bit multi level cell (MLC). In case of a MLC nonvolatile memory device, to program k number of bits in one memory cell, any one of 2^{k} number of threshold voltages has to be formed in the memory cell. In case of storing two (2) bits in one memory cell, due to a minute electrical characteristic difference between memory cells, threshold voltages of memory cells in which same data is programmed may form a specific range of a threshold voltage distribution. Each threshold voltage distribution may correspond to 2^{k} number of data values that may be generated by k number of bits respectively.

Referring to FIG. 8, in case of a 2-bit MLC nonvolatile memory device, three program threshold voltage states of P1(2-e), P2(2-c) and P3(2-a) which are state distributions immediately after a program operation and a threshold voltage state distribution of E(2-g) which is one erase state are formed. A charge loss does not occur in P1(2-e), P2(2-c) and P3(2-a) immediately after a program operation and thereby state distributions do not overlap one another. In FIG. 8, a read voltage exists by a state distribution of each threshold voltage. In case of 2 bits, three read voltages VreadA, VreadB and VreadC are determined. The VreadA, VreadB and VreadC may be default voltages predetermined during a manufacturing process but the inventive concept is not limited thereto. In FIG. 8, for brevity of description, 2 bits were described as an illustration but the inventive concept is not limited thereto. In case of a 3-bit nonvolatile memory device, 7 program distributions and 1 erase distribution exist and in case of a 4-bit nonvolatile memory device, 15 program distributions and 1 erase distribution exist.

In the case that time goes by after a 2-bit multi level cell (MLC) nonvolatile memory device performs a program operation and time goes by while a 2-bit multi level cell (MLC) nonvolatile memory device repeatedly performs program and erase operation, due to characteristic deterioration of a flash memory cell, threshold voltage distributions of program and erase states may be changed due to a charge loss.

As described in FIG. 8, in case of a nonvolatile memory device, as time goes by, there occurs a charge loss because electrons trapped in a floating gate or a tunnel oxide layer are emitted. A tunnel oxide layer is deteriorated while program and erase operation are repeatedly performed and thereby a charge loss may be further increased.

A charge loss can reduce a threshold voltage of a memory cell, thereby moving a threshold voltage distribution to the left of the drawing. Thus, as illustrated, adjacent threshold voltage distributions may overlap one another. E(2-g) and P1′(2-f) may overlap each other, P1′(2-f) and P2′(2-D) may overlap from each other and P2′(2-D) and P3′(2-b) may overlap each other. If distributions overlap one another, when a specific read voltage is applied, data being read may include a lot of errors. For example, when VreadA is applied, if memory cells are in an on state, those indicate read data of P2 side and if memory cells are in an off state, those indicate data of P3 side. However, in case of overlapped part, since memory cells of P3 may be read as an on state, an error bit may be incurred. Thus, as threshold distributions overlap one another, a lot of errors may be included in data that has been read.

In the case that error bits included in the data that has been read cannot be corrected using an error correction code (ECC) unit (or ECC circuit), uncorrectable ECC (UECC) errors may occur. Due to the nature of a flash memory cell, if long time goes by after a program operation, an error bit level increases and if more time goes by, UECC may occur. A phenomenon that UECC occurs is called a retention decline. To prevent UECC occurrence, an operation of moving data of a memory block (source block) deteriorated by a retention decline to a fresh block (destination block) in advance is performed in a memory system, which is called a reclaim. That is, if deteriorated data of the source block is written in a destination block which is a new memory block, data written in the memory cell can be retained for a longer time according to a command of a host.

In case of a general reclaim operation, if UECC danger is sensed in a read operation, a reclaim is performed after receiving a write command. That is, after receiving a write command from a host, in a write operation, data stored in a deteriorated memory block is moved to a new memory block which is a destination block. In such a reclaim operation, if a read operation is continuously repeated many times without a intervening write command, a chance of recovering deteriorated data is reduced and thereby UECC may occur. However, if a read reclaim is unconditionally performed for each read operation, performance of a read operation is degraded and the increased use of memory blocks causes shortening the life of memory devices.

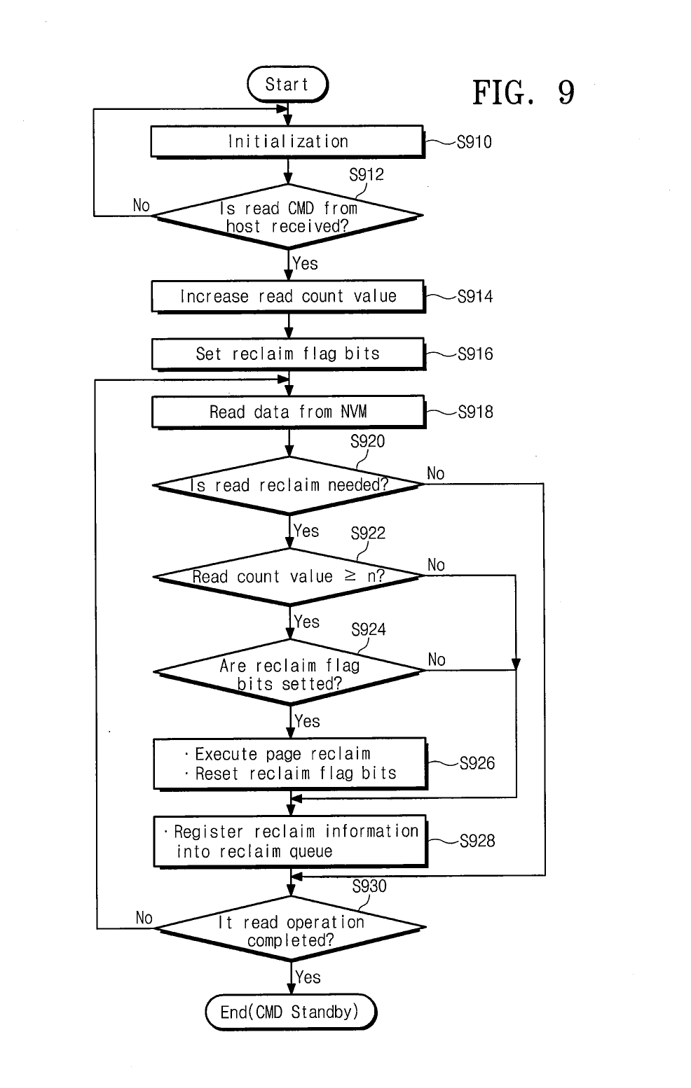

To solve those problems, in an embodiment of the inventive concept, using the method such as described in FIG. 9, a read reclaim in a repetitive read operation is effectively performed while minimizing or reducing performance degradation in the read operation. In particular, FIG. 9 is a flow chart for explaining a read reclaim operation for recovering real time data according to embodiments of the inventive concept. Referring to FIG. 9, after performing an initialization operation in a step S910, the memory controller 1200 of FIG. 1 can sequentially perform steps of S912, S914, S916, S918, S920, S922 and S924 to check whether a read command consecutively occurs more than the specific number of times from the host. The initialization operation may include initialization of all sorts of flags or buffers and initialization of the counting unit 1250. In step S912, the memory controller 1200 checks whether a read command CMD is received from the host.

In step S914, the counting unit 1250 of the memory controller 1200 increases a read counting value by 1 upon receiving a read command CMD. That is, the read counting value can be increased by 1 whenever a read command is received. In step S916, the memory controller 1200 can set reclaim flag bits to perform a needed read reclaim without degradation of read performance. For example, in the case that data is deteriorated in a third page, if a read reclaim is performed on only a first page, reclaim flag bits may be used to distinguish between the first page on which a read reclaim is performed and the remaining second and third pages. By using the reclaim flag bits, the read reclaim may be performed several times over. In step S918, the memory controller 1200 reads data from a nonvolatile memory NVM such as a flash memory. The data that has been read may be page data stored in a multi level cell block. An error bit level with respect to the page data can be checked through the ECC unit 1260.

In step S920, the memory controller 1200 determines whether a read reclaim is needed during a read operation. In this case, page reclaim event occurrence may be performed by checking an error bit level with respect to page data stored in a multi level cell block. In step S922, the memory controller 1200 checks whether a counting value of a read command consecutively occurs more than a specific number of times (n) (n varies to several tens through several hundreds of thousands of times). The specific number of times may be determined according to a read disturb characteristic of the multi level cell block. If a write command occurs after the read command consecutively occurs less than the specific number of times, the specific number of times may be reset to 0.

In step S924, the memory controller 1200 checks whether reclaim flag bits are set. This is because in the case that reclaim flag bits are not set, it is not necessary to perform a read reclaim during a read operation. In the case that through the step S922, it is checked that the read command consecutively occurs more than the specific number of times, an operation mode may be set to a page reclaim enable state during a read operation. There may be also performed in the step S910 that an operation mode may be set to a page reclaim enable state.

In step S926, when a page reclaim event occurs, a page reclaim is executed during a read operation and reclaim flag bits are reset. When the page reclaim is executed, page data error-corrected after being stored in the multi level cell block may be moved to a page of a single level cell block. The multi level cell block may include a plurality of memory cells storing 3-bit data. The page reclaim may be executed on page data in which the page reclaim event occurs during the read operation.

For example, in the case that a plurality of page reclaim events occurs after a plurality of page data is read in a single read operation according to a read command, a page reclaim may be executed only on page data in which a page reclaim event occurred. The page reclaim is executed by a super page size and the super page size may be defined by the number of NAND 1 pages times the number of plains. In the case that page data on which the page reclaim was executed is read again, the page data being read again may be skipped from a target of the page reclaim being executed during a read operation.

In step S928, reclaim information may be stored in a reclaim queue 1232 of FIG. 3. Reclaim information stored in the reclaim queue 1232 can be referred in a next reclaim operation or a subsequent memory operation. In step S930, it is checked whether a read operation is completed and in the case that the read operation is completed, a standby state of waiting for a next command is progressed. Using the read reclaim method described in FIG. 9, a real time data recovery is performed while minimizing or reducing performance degradation.

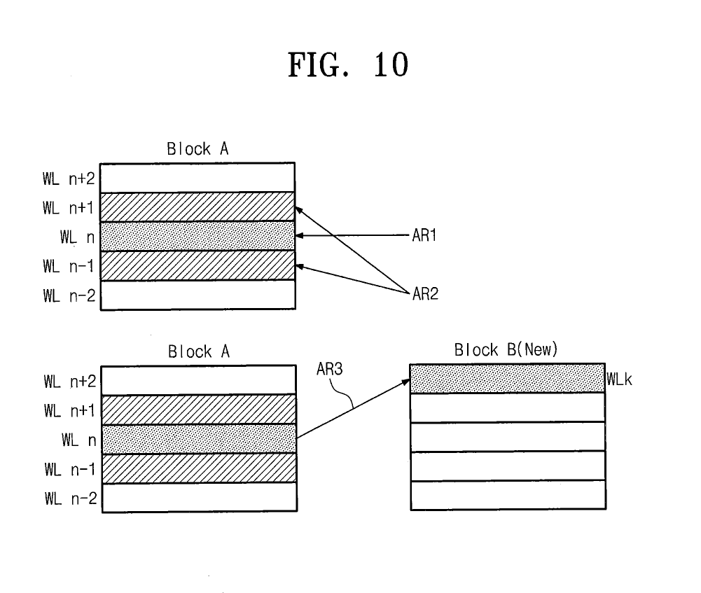

FIG. 10 is a schematic view for explaining a reclaim operation method for removing a disturb factor according to embodiments of the inventive concept. Referring to FIG. 10, a memory block BLOCK A represents a source block which becomes a reclaim target and a memory block BLOCK B represents a destination block in which deteriorated data is written. A reclaim operation of FIG. 10 is performed in a write operation after receiving a write command. In this case, though the deteriorated data of the memory block BLOCK A are data of memory cells connected to word lines WLn+1 and WLn−1 adjacent to a select word line WLn, data of memory cells connected to a reclaim factor word line WLn moves to memory cells connected to a new memory block when a write command is received.

As indicated by a reference numeral AR1, in the case that a word line WLn is selected in a read operation, as indicated by a reference numeral AR2, an error bit level of memory cells connected to the word lines WLn+1 and WLn−1 adjacent to the select word line WLn with respect to data is checked during the read operation. In the event an error bit level is higher than a specific level, a reclaim is needed. In the case that a reclaim is needed, data of memory cells connected to the reclaim factor word line WLn is stored in the buffer 1240 of FIG. 2. The data memory cells connected to the reclaim factor word line WLn stored in the buffer 1240 is reclaimed after receiving a write command. As indicated by a reference numeral AR3, when a reclaim is executed in a write operation, data of memory cells connected to the reclaim factor word line WLn is written in memory cells connected to a word line of a new memory block.

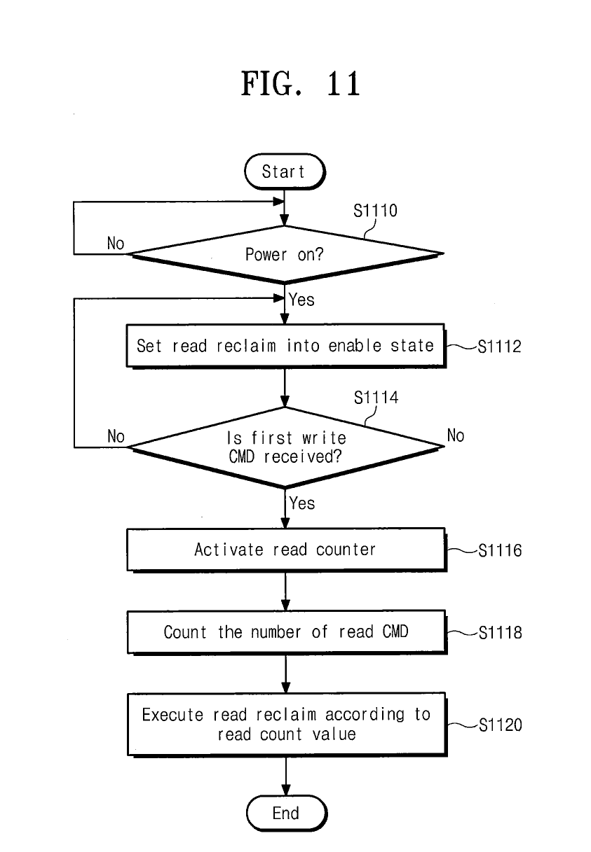

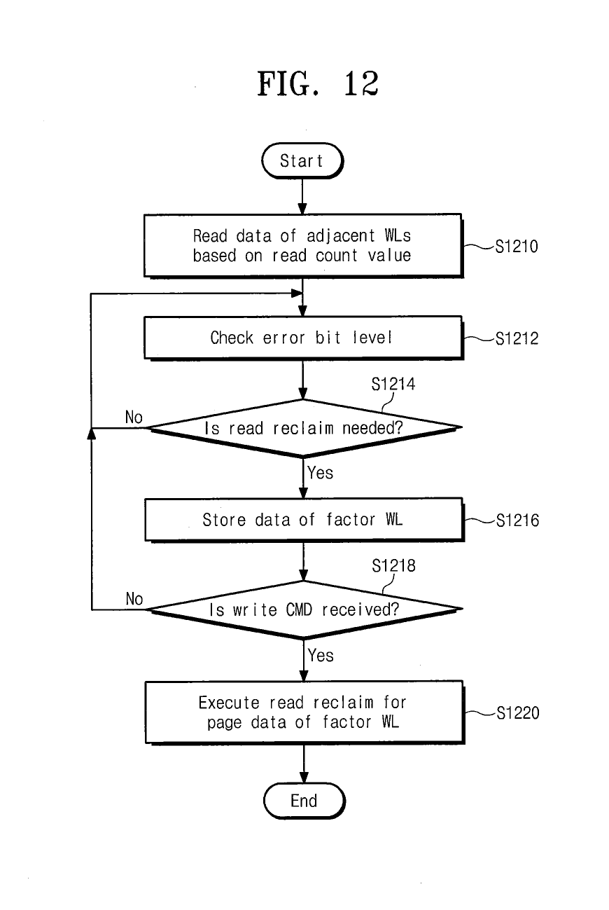

FIG. 11 is a flowchart for explaining an operation relation between a read reclaim setting and a counting unit when power is supplied according to embodiments of the inventive concept. If power-on of a memory system is performed in step S1110, the memory controller 1200 performs a step S1112 regardless of a counting value of the counting unit 1250. The step S1112 is a step of setting a read reclaim to an enable state. After the step S1112 is performed, the memory controller 1200 checks whether a write command is first received in step S114. If a write command is first received in step S114, a read counter is reset and activated in step S1116. That is, activation of a read counter in the step S1116 means that the counting unit 1250 enters a counting enable state. In step S1118, the counting unit 1250 begins to count the number of consecutive read commands. In step S1120, a read claim is executed according to a read counting value. The read reclaim may be performed selectively using methods such as illustrated in FIG. 9 or FIG. 12.

FIG. 12 is a flow chart for explaining a reclaim operation for removing a disturb factor according to FIG. 10. In a NAND flash memory, memory cells connected to peripheral word lines are more greatly disturbed compared with memory cells connected to a word line in which a read operation is performed. An error bit level has to be checked to perform a read reclaim but in the case that data of memory cells connected to a specific word line is repeatedly read, it is difficult to check a disturbance degree of memory cells connected to peripheral word lines. Thus, since data of memory cells connected to peripheral word lines is not reclaimed, UECC may occur. To prevent this, in another embodiment of the inventive concept, an error bit level is checked by reading data of memory cells connected to peripheral word lines at every number of times of read operations which is set. In the case that a read reclaim is needed, a fact that a read reclaim is needed is recorded in a buffer and after that, a reclaim is performed during a write operation.

In the case that a read reclaim is needed, as illustrated in FIG. 10, data of memory cells connected to a reclaim factor word line WLn moves to memory cells connected to a new memory block. Consequently, data of a page which was actually read is copied to a new SLC memory block. Accordingly, as a select word line WLn is reclaimed, memory cells connected to adjacent word lines WLn−1 and WLn+1 of FIG. 10 are not additionally disturbed. 3-bit MLC is vulnerable to a read disturbance compared with 2-bit MLC. Referring to FIG. 12, representing a reclaim method according to another embodiment of the inventive concept, in step S1210, the memory controller 1200 reads data of memory cells connected to word lines WLn+1 and WLn−1 adjacent to a select word line WLn according to a read counting value. The step S1210 is performed when a read command consecutively occurs more than specific number of times. However, the step S1210 may be periodically executed during a read operation even if it is not a repetitive read operation. In step S1212, an error bit level with respect to the data which has been read is checked through the ECC unit 1260 during a read operation. It may be determined whether a reclaim is needed according to a level of uncorrectable error occurrence probability by an ECC execution result. In step S1214, if it is checked that a reclaim is needed, in a step S1216, data of memory cells connected to a reclaim factor word line WLn is stored in the buffer 1240. In the case that memory cells are SLC, one (1) page data is stored but in the case that memory cells are 3-bit MLC, three (3) page data is stored.

In step S1218, if it is checked that a write command is received, a step S1220 is performed. In the step S1220, as described through FIG. 10 and the aforementioned description, data of memory cells connected to the stored reclaim factor word line is written in memory cells connected to a word line of a new memory block. In the case that memory cells connected to the factor word line constitute a 3-bit MLC memory block, the memory cells connected to a word line of the new memory block may be cells storing single bit data respectively.

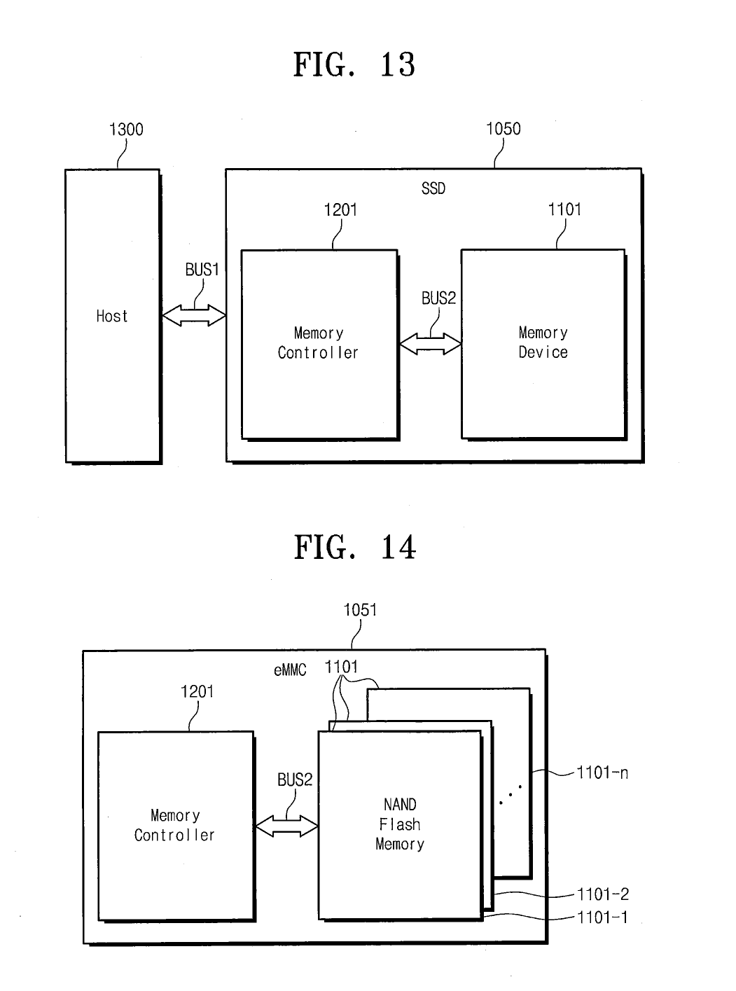

FIG. 13 is a block diagram illustrating an embodiment of a memory system in accordance with the inventive concept. Referring to FIG. 13, a memory system 1050 may include a memory controller 1201 and a memory device 1101 having a flash memory cell array. The memory controller 1201 and the memory device 1101 are connected to each other through a bus BUS2. The memory system 1050 is connected to a host 1300 through a bus BUS1. The bus BUS1 may be a bus being communicated through at least one of various interface protocols such as a USB (universal serial bus) protocol, a MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, a SCSI (small computer small interface) protocol, an ESDI (enhanced small disk interface) protocol, and an IDE (integrated drive electronics) protocol. In the case that the memory system 1050 is constituted by a solid state drive (SSD), the memory controller 1201 can perform the read reclaim operation such as described in the embodiments of the inventive concept. Thus, a read reclaim of a repetitive read operation is effectively accomplished while performance degradation is minimized or reduced in a read operation of SSD.

FIG. 14 is a block diagram illustrating another embodiment of a memory system in accordance with the inventive concept. Referring to FIG. 14, a memory system 1051 may include a memory controller 1201 and a NAND flash memory 1101. The memory controller 1201 and the NAND flash memory 1101 are connected to each other through a bus BUS2. In the case that the memory system 1051 is constituted by an eMMC, the memory controller 1201 can perform the read reclaim operation such as described in the embodiments of the inventive concept. Thus, performance and life of eMMC are improved. In case of performing a reclaim process only in a write operation, UECC may be more likely to occur before a reclaim operation by a concentrating read operation. Thus, in this case, the reclaim process such as described in FIG. 9 being executed in a read operation may be applied. Concern about a read disturbance with respect to 3-bit MLC, that is, TLC memory device, may provide difficulties during a TLC application. If adopting a reclaim method being executed only in a write operation, in the case that only read operation is repeatedly performed, it is difficult to guarantee reliability with respect to disturbance. The embodiment of the inventive concept has an advantage that deteriorated data can be recovered in real time through disturb vulnerable host pattern sensing.

In case of a general reclaim method, even in case of reaching a risk level that a high order page data is deteriorated first, a reclaim is sequentially performed from low order page data. Only when pages of a source memory block of a reclaim are all moved to other memory block, is a reclaim completed. The embodiment of the inventive concept adopts a partial reclaim method that only one page or some pages are copied to a new memory block in a read operation. The partial reclaim method is to perform a refresh on only data of a page in which UECC may actually occur during a read operation to prevent a read time-out and performance degradation. Data of the remaining pages which are not initially reclaimed are later reclaimed during a write operation.

In embodiments of the inventive concept, a reclaim can be performed by only maximum super page (a page size being used in firmware, NAND page size times number of planes) unit during a read operation to prevent read performance degradation. Data of a unit smaller than the super page is copied to other memory block by only corresponding size. If using data corrected by a defensive code and ECC as it is, time spent on a page reclaim is reduced. In the eMMC of FIG. 14, the NAND flash memory 1101 may be a three dimensional NAND flash memory and a memory cell may be a 3 bit MLC.

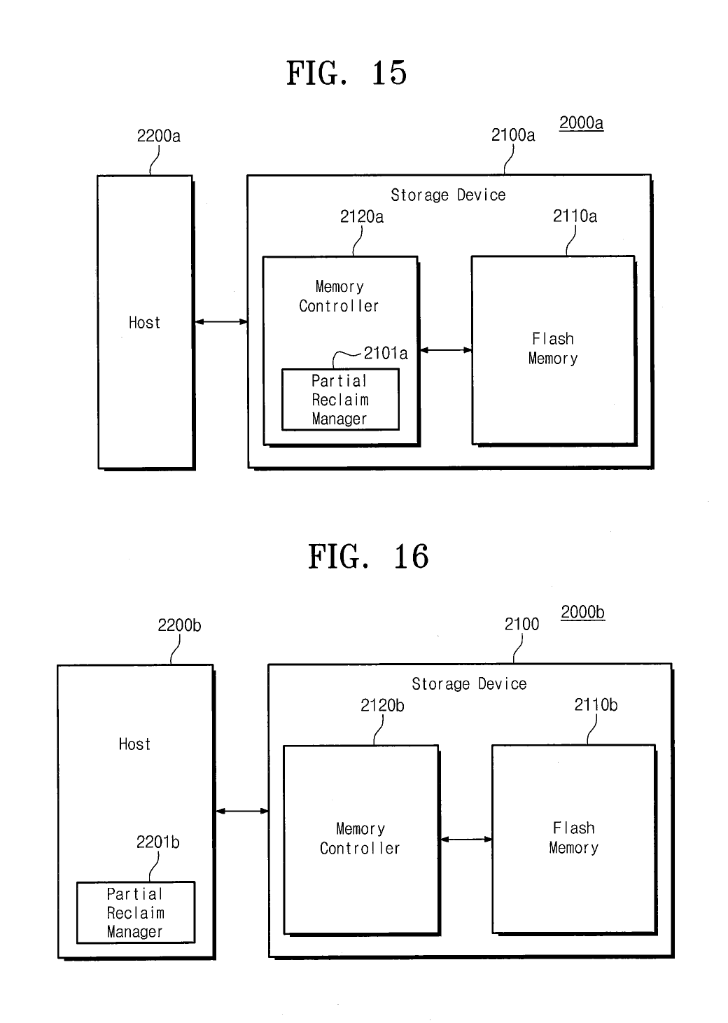

FIGS. 15 and 16 are block diagrams illustrating other various embodiments of a memory system in accordance with the inventive concept. Referring to FIGS. 15 and 16, a memory system (2000a, 2000b) includes a storage device (2100a, 2100b) and a host (2200a, 2200b). The storage device (2100a, 2100b) includes a flash memory (2110a, 2110b) and a memory controller (2120a, 2120b). The storage device (2100a, 2100b) includes a memory card (e.g., SD, MMC, etc.) or a removable mobile storage device (e.g., USB memory, etc.). The storage device (2100a, 2100b) may be connected to the host (2200a, 2200b) to be used. The storage device (2100a, 2100b) exchanges data with the host (2200a, 2200b) through a host interface. The storage device (2100a, 2100b) can be supplied with power from the host (2200a, 2200b) to perform an internal operation.

In case of FIG. 15, the memory controller 2120a includes a partial reclaim manager 2101a controlling a reclaim operation. In case of FIG. 16, the host 2200b includes a partial reclaim manager 2201b controlling a reclaim operation. The partial reclaim manager can control a reclaim operation of a page unit according to the operation control flow of FIG. 9 or FIG. 12. The partial reclaim manager, in case of FIG. 2, may be constituted by relevant blocks such as the control unit 1230, the counting unit 1250 and the ECC unit 1260. Thus, durability with respect to a repeated read operation becomes high without performance degradation of the storage device (2100a, 2100b).

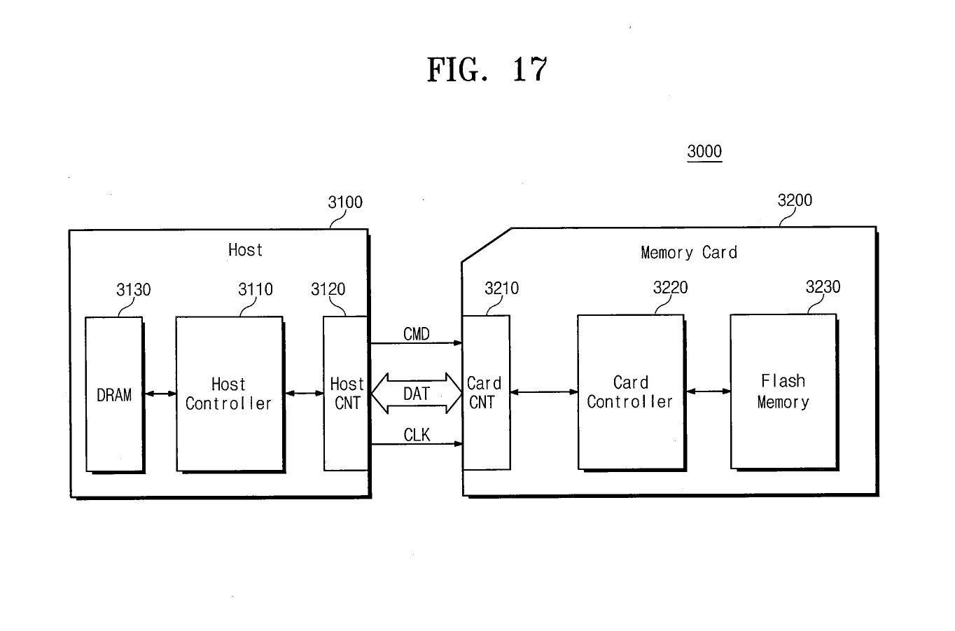

FIG. 17 is a block diagram illustrating a memory card system including a memory system in accordance with the inventive concept. Referring to FIG. 17, a memory card system 3000 includes a host 3100 and a memory card 3200. The host 3100 includes a host controller 3110, a host connection unit 3120 and a DRAM 3130. The host 3100 writes data in the memory card 3200 or reads data stored in the memory card 3200. The host controller 3110 transmits a command (for example, a write command), a clock signal CLK generated from the host 3100, and data DATA to the memory card 3200 through the host connection unit 3120. The DRAM 3130 is a main memory of the host 3100.

The memory card 3200 may include a card connection unit 3210, a card controller 3220 and a flash memory 3230. In response to a command received through the card connection unit 3210, the card controller 3220 stores data in the flash memory 3230 in synchronization with a clock signal generated from the card controller 3220. The flash memory 3230 stores data transmitted from the host 3100. For example, in the case that the host 3100 is a digital camera, the flash memory 3230 stores image data. The memory card system 3000 may include a partial reclaim manager in the card controller 3220 or the flash memory 3230. As described above, by including the partial reclaim manager, a read reclaim is effectively accomplished in real time while minimizing or reducing performance degradation of the system.

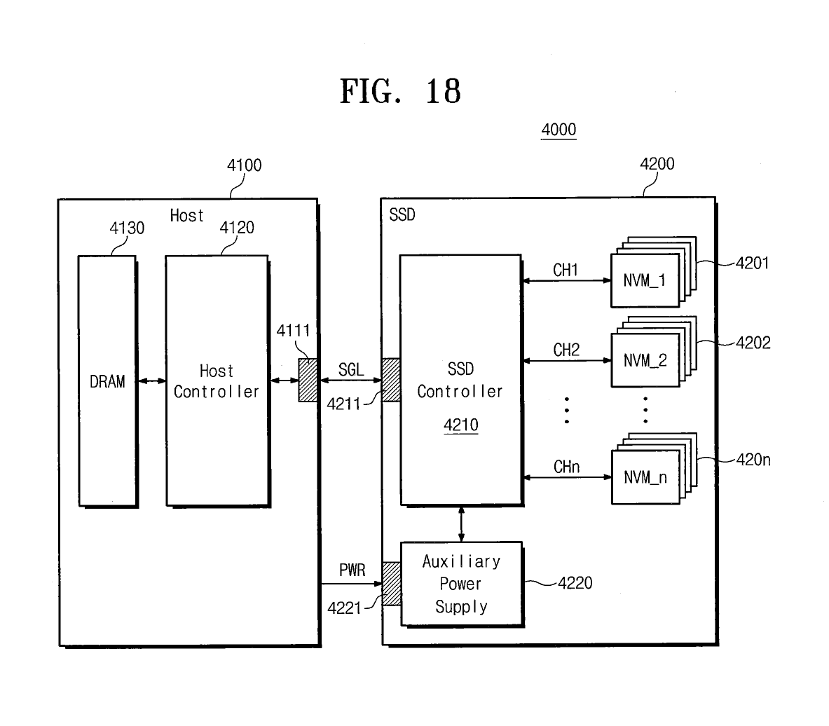

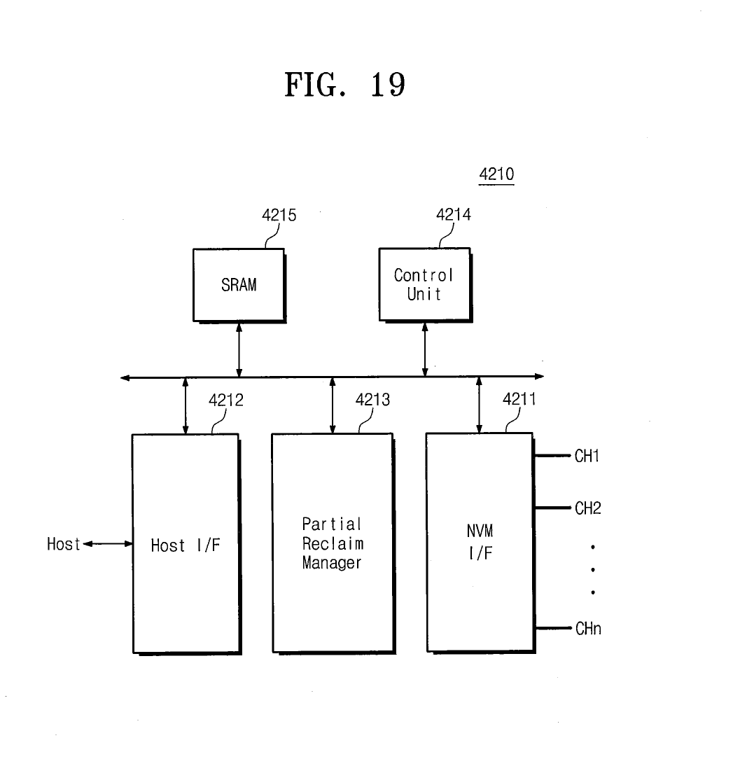

FIG. 18 is a block diagram illustrating a solid state drive (SSD) system including a memory system in accordance with the inventive concept. Referring to FIG. 18, the SSD system 4000 includes a host 4100 and a SSD 4200. The host 4100 includes a host interface 4111, a host controller 4120 and a DRAM 4130. The host 4100 writes data in the SSD 4200 or reads data stored in the SSD 4200. The host controller 4120 transmits a signal SGL such as a command, an address, a clock signal, etc. to the SSD 4200 through the host interface 4111. The DRAM 4130 functions as a main memory of the host 4100. The SSD 4200 exchanges a signal SGL with the host 4100 through the host interface 4211 and is inputted with power through a power connector 4221. The SSD 4200 may include a plurality of nonvolatile memories 4201˜420n, a SSD controller 4210 and an auxiliary power supply 4220. The nonvolatile memories 4201˜420n can be embodied by a PRAM, a MRAM, an ReRAM, a FRAM, etc. besides a NAND flash memory.

The flash memories 4201˜420n are used as a storage medium of the SSD 4200. The flash memories 4201˜420n can be connected to the SSD controller 4210 through a plurality of channels CH1˜CHn. One or more flash memories can be connected to each channel. Flash memories connected to each channel can be connected to a same data bus.

The SSD controller 4210 exchanges a signal SGL with the host 4100 through the host interface 4211. The signal SGL includes a command, an address, data, etc. The SSD controller 4210 writes data in a corresponding flash memory or reads data from a corresponding flash memory according to a command of the host 4100.

The auxiliary power supply 4220 is connected to the host 4100 through the power connector 4221. The auxiliary power supply 4220 can receive power from the host 4100 to be charged. The auxiliary power supply 4220 can be located inside or outside the SSD 4200. For example, the auxiliary power supply 4220 is located on a main board and can provide auxiliary power to the SSD 4200.

FIG. 19 is a block diagram illustrating a constitution of SSD controller illustrated in FIG. 18. Referring to FIG. 19, the SSD controller 4210 includes a NVM interface 4211, a host interface 4212, a partial reclaim manager 4213, a control unit 4214 and a SRAM 4215. The NVM interface 4211 scatters data transmitted from a main memory of the host 4100 to the channels CH1˜CHn. The NVM interface 4211 transmits data read from the nonvolatile memories 4201˜420n to the host 4100 through the host interface 4212.

The host interface 4212 provides an interfacing with the SSD 4300 in response to a protocol of the host 4100. The host interface 4212 can communicate with the host 4100 using a universal serial bus (USB), a small computer system interface (SCSI), a PCI express, an ATA, a parallel ATA (PATA), a serial ATA (SATA), a serial attached SCSI (SAS), etc. The host interface 4212 can perform a disk emulation function of supporting so that the host 4100 recognizes the SSD 4200 as a hard disk drive (HDD).

The partial reclaim manager 4213 can manage a reclaim operation of the nonvolatile memories 4201˜420n. The control unit 4214 analyzes and processes a signal SGL inputted from the host 4100. The control unit 4214 controls the host 4100 or the nonvolatile memories 4201˜420n through the host interface 4212 or the NVM interface 4211. The control unit 4214 controls an operation of the nonvolatile memories 4201˜420n according to firmware for driving the SSD 4200. The SRAM 4215 can be used to drive software (S/W) being used for an efficient management of the nonvolatile memories 4201˜420n. The SRAM 4215 can store meta data received from a main memory of the host 4100 or stores cache data. In a sudden power off operation, meta data or cache data stored in the SRAM 4215 can be stored in the nonvolatile memories 4201˜420n using the auxiliary power supply 4220. By performing the reclaim operation described above, the SSD system 4000 can reduce a read error that occurs due to a disturbance phenomenon of the nonvolatile memories 4201˜420n in a repeated read operation.

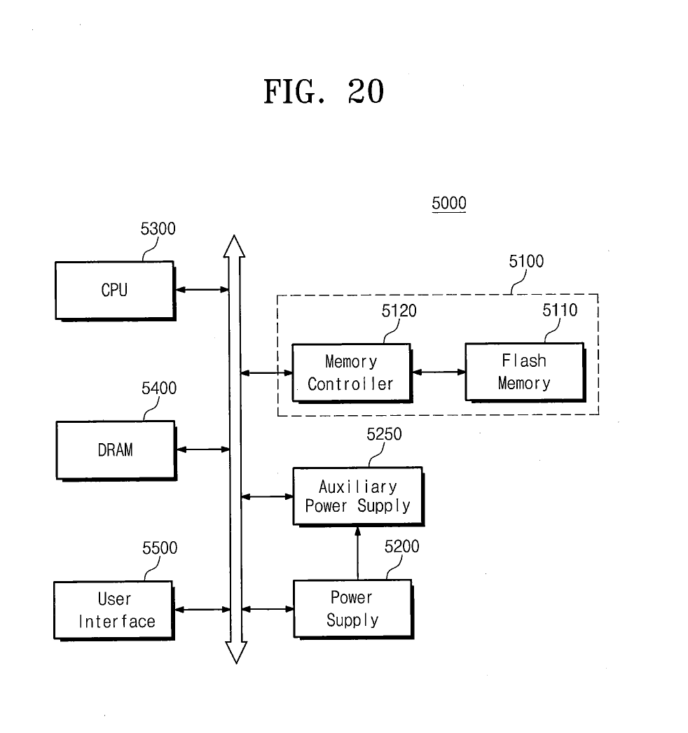

FIG. 20 is a block diagram a memory system in accordance with the inventive concept embodied by an electronic device. The electronic device 5000 may be provided by one of a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game machine, a navigation device, a black box, a digital camera, a digital multimedia broadcasting (DMB) player, a three dimensional television, a smart television, a digital audio recorder, a digital audio player, a digital picture recorder, a digital picture player, a digital video recorder, a digital video player, a storage constituting a data center, a device that can transmit and receive information in a wireless environment, one of various electronic devices constituting a home network, one of various electronic devices constituting a computer network, one of various electronic devices constituting a telematics network, and one of various constituent elements constituting a RFID device or a computing system.

Referring to FIG. 20, the electronic device 5000 includes a memory system 5100, a power supply 5200, an auxiliary power supply 5250, a central processing unit 5300, a DRAM 5400, and a user interface 5500. The memory system 5100 includes a flash memory 5110 and a memory controller 5120. The memory system 5100 can be built in the electronic device 5000.

As described above, the electronic device 5000 can reduce a read error that occurs due to a disturbance phenomenon of the flash memory 5110.

According to the embodiments of the inventive concept, a read reclaim in a repeated read operation is effectively accomplished while performance degradation is minimized or reduced in a read operation.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein.

What is claimed is:

1. A method of operating a nonvolatile memory device, comprising:
counting a number of consecutive read operations performed on a first memory region within the nonvolatile memory device; and
executing a page reclaim operation on the first memory region in response to detecting that a count in the number of consecutive read operations meets or exceeds a threshold count.

2. The method of claim 1, wherein said executing a page reclaim operation comprises checking an error bit level within a page of data stored in a multi-level cell block within the memory device.

3. The method of claim 2, wherein said executing a page reclaim operation comprises moving page data from the multi-level cell block to a single-level cell block in the memory device and error correcting the page data during said moving.

4. The method of claim 2, wherein the multi-level cell block comprises a block of 3-bit nonvolatile memory cells.

5. The method of claim 1, wherein the count in the number of consecutive read operations is reset in response to an operation to write page data into the first memory region.

6. The method of claim 1, wherein said executing a page reclaim operation comprises executing a page reclaim operation on nonvolatile memory cells associated with a selected word line in the memory device and checking an error bit level in nonvolatile memory cells associated with a word line in the memory device that is immediately adjacent the selected word line.

7. A read reclaim method for real time data recovery comprising:
checking whether a read command consecutively occurs more than a specific number of times;
setting an operation mode to a page reclaim enable state during a read operation in the case that the read command consecutively occurs more than the specific number of times; and
executing a page reclaim during the read operation in the case that an event of the page reclaim occurs.

8. The read reclaim method of claim 7, wherein the page reclaim event occurrence is performed by checking an error bit level with respect to page data stored in a multi level cell block.

9. The read reclaim method of claim 8, wherein when the page reclaim is executed, page data error-corrected after being stored in the multi level cell block is moved to a page of a single level cell block.

10. The read reclaim method of claim 8, wherein the multi level cell block comprises a plurality of memory cells storing 3 bit data.

11. The read reclaim method of claim 7, wherein the specific number of times is determined according to a read disturb characteristic of the multi level cell block.

12. The read reclaim method of claim 7, wherein the page reclaim is executed with respect to page data in which the page reclaim event occurs during a read operation.

13. The read reclaim method of claim 7, wherein in the case that a plurality of page reclaim events occurs after a plurality of page data is read in a single read operation according to the read command, a page reclaim is executed on page data in which a page reclaim event occurs first during a read operation.

14. The read reclaim method of claim 13, wherein in the case that page data on which the page reclaim was executed is read again, the page data being read again is skipped from a target of the page reclaim being executed during a read operation.

15. The read reclaim method of claim 13, wherein if a write command occurs after the read command consecutively occurs, the specific number of times is reset to 0

16. A read reclaim method for performing real time data recovery comprising:
detecting whether a read command consecutively occurs more than a specific number of times;
checking an error bit level with respect to data of memory cells connected to word lines adjacent to a select word line during a read operation in the case that the read command consecutively occurs more than the specific number of times;
storing data of memory cells connected to a reclaim factor word line in the case that a reclaim is needed; and
moving data of memory cells connected to the stored reclaim factor word line to memory cells connected to a word line of a new memory block when a write command is received.

17. The read reclaim method of claim 16, wherein the memory cells connected to the factor word line constitute a multi level cell block.

18. The read reclaim method of claim 17, wherein the memory cells connected to the word line of the new memory block store single bit data.

19. The read reclaim method of claim 17, wherein the multi level cell block comprises a plurality of memory cells storing 3 bit data.

20. The read reclaim method of claim 17, wherein the judgment whether a reclaim is needed is performed according to a level of uncorrectable error occurrence probability by an ECC execution result.
